(19) United States
(12) Patent Application Publication
(10) Pub. No.: US 2022/0181915 A1
(43) Pub. Date: Jun. 9, 2022

(54) HOLDING FIXTURE FOR FASTENING A MOBILE TERMINAL TO A MODULE

(71) Applicant: Robert Bosch GmbH, Stuttgart (DE)

(72) Inventor: Yonggang Du, Frankfurt a.M. (DE)

(21) Appl. No.: 17/601,534

(22) PCT Filed: Jun. 17, 2020
(86) PCT No.: PCT/EP2020/066769

§ 371 Date: Oct. 5, 2021

(30) Foreign Application Priority Data
Jun. 18, 2019 (DE) 10 2019 208 810.4

(51) Int. Cl. H02J 50/12; H02J 50/00; H02J 7/00; H02J 50/40; F16M 11/04; F16M 13/02

(52) U.S. Cl. CPC H02J 50/12; H02J 50/005; H02J 7/0044; H04M 1/04; F16M 11/041; F16M 13/02; H02J 50/40

(57) ABSTRACT

A holding fixture for fastening a mobile terminal to a module having fastening elements for attaching the holding fixture. The mobile terminal includes a charging coil for contactlessly charging an energy store. The holding fixture includes a window region and a support frame for holding the mobile terminal and for attachment to the module. The support frame extends about the window region. The window region is covered by a supported mobile terminal, when the holding fixture is attached to the module. The holding fixture includes a transmitter unit for generating a resonant inductive coupling with the charging coil. With the aid of a transmitting coil, the transmitter unit generates a resonant inductive coupling acting at least partially through the window region. Consequently, a holding fixture is provided, which includes a window region and has an improved efficiency in the charging of the energy store of a supported mobile terminal.

### FIELD

The present invention relates to a holding fixture for fastening a mobile terminal to a module, and a system.

### BACKGROUND INFORMATION

A module securely mounted on a bicycle, for intelligent cycling, using normal bicycles or electric bicycles, is supplied with voltage by a battery in the case of a normal bicycle, or by the storage battery of an electric bicycle. In addition, a mobile terminal, such as a smartphone or a tablet, in the form of a display of the module, may be connected mechanically to the module with the aid of a protective covering specially developed for this. If a mobile terminal is used by the module as a display, then there is a need for wirelessly charging the mobile terminal with energy from the module during the ride, in order to extend the service life of its battery. This may be achieved by inserting the smartphone into a protective covering specially designed for this and sliding the protective covering into the module, using a mechanical guideway. To charge the mobile terminal wirelessly, a standardized Qi transmitter, together with a coil, may be built into the protective covering; the protective covering including an electrical contact for connection to an electrical contact of the module, in order to supply operating voltage. However, the above-described design for wirelessly charging mobile terminals with energy from the module only has a high efficiency of power transmission, if the position of the coil of the Qi transmitter built into the protective covering coincides with the position of the coil of the Qi receiver built into the mobile terminal, in order to cover the magnetic field.

During the use of a universal holder for securing an arbitrary mobile terminal to the module, the holder is fastened to the module with the aid of a mechanical structure and remains securely mounted, even when the mobile terminal is removed from the holder and is no longer used for cycling. In addition, the holder includes an open section in the center. The open section results in a material reduction, which promotes the charging of a supported mobile terminal. If the module has its own built-in display, the open section may also allow an unencumbered view of the display, when no mobile terminal is supported by the holder. The holder may further include a Qi transmitter for transmitting power to a Qi receiver of the mobile terminal. However, the efficiency of the power transmission is low, since the Qi transmitter is not normally positioned coincidently with the Qi receiver of the mobile terminal.

An object of the present invention is to provide a holding fixture, which includes a window region and has an improved efficiency in the charging of the energy store of a supported mobile terminal.

### SUMMARY

Example embodiment and refinements of the present invention are disclosed herein.

In accordance with the present invention, a holding fixture is provided for fastening a mobile terminal to a module. In an example embodiment of the present invention, the holding fixture has fastening elements for attaching the holding fixture; the mobile terminal includes a charging coil for contactlessly charging an energy store; the holding fixture includes a window region and a support frame for holding the mobile terminal and for attachment to the module; the support frame extends about the window region, and the window region is covered by a supported mobile terminal, when the holding fixture is attached to the module; the holding fixture includes a transmitter unit for generating a resonant inductive coupling with the charging coil; with the aid of a transmitting coil, the transmitter unit generating a resonant inductive coupling acting at least partially through the window region.

An example embodiment of the present invention provides a transmitting coil, which produces a resonant inductive coupling acting at least partially through the window region. Since a charging coil of a mobile terminal in the holding fixture is positioned, as a rule, at the window region, a resonant inductive coupling acting at least partially through the window region produces an improved efficiency in the charging of the energy store of the supported mobile terminal. To that end, the transmitting coil may be situated in the window region, if a mobile terminal is supported by the holding fixture, and/or the charging coil may be positioned around the window region.

In a first exemplary embodiment of the holding device in accordance with the present invention, the transmitting coil may be situated on a separate support element; the support element being detachably connected to the support frame.

Using the separate support element, the transmitting coil may be positioned at the window region in such a manner, that the support element produces a resonant inductive coupling through the window region, which, in the absence of the mobile terminal, allows, e.g., a view of an underlying display of the module or, e.g., access through to operating elements of the module. When a mobile terminal is supported by the holding fixture, the mobile terminal masks the view through the window region, which means that the support element may position the transmitting coil in the window region, so that the transmitting coil may produce a resonant inductive coupling acting at least partially through the window region. Due to the absence of material in the window region, this allows more efficient charging of the mobile terminal.

In a first example of the support element of the present invention, the support element may be detachably connected to the holding fixture and may extend, in a connected state, from the support frame into the window region.

Consequently, depending on the need, the separate support element may be coupled to the holding fixture or detached from it. Therefore, at the same time, the transmitting coil is coupled to the holding fixture or detached from it. Thus, the transmitting coil may be used in a flexible manner, and in the absence of a mobile terminal, it may be removed from the window region.

In addition, the support frame may include a first electrical connecting element; the support element including a second electrical connecting element for connection to the first electrical connecting element.

Consequently, an electrical connection is automatically provided between the transmitting coil of the separate support element and the holding device, when the support element is connected to the support frame of the holding fixture; the support element being able to be connected electrically to the module.

In a further alternative or additional example of the support element of the present invention, the support element and the transmitting coil may have a rolled-up state and an unrolled state, and in an unrolled state, they may extend from the transmitter unit across the window region.

In this instance, the transmitting coil and the support element are connected permanently to the support frame. In the rolled-up state, the transmitting coil and the support element clear the window region. In the unrolled state, the transmitting coil and the support element are positioned in the window region, which means that the transmitting coil may produce a resonant inductive coupling acting at least partially through the window region.

In this context, the support frame may include a locking element for detachably retaining the support element in the unrolled state.

Consequently, in the unrolled state, the support element may be locked to the support frame with the aid of the locking element. In this instance, after the locked connection is released, the support element and the transmitting coil may automatically pass over into the rolled-up state and automatically clear the window region after the locked connection is released. To that end, a spring element may be provided, which drives the support element, along with the transmitting coil, into the rolled-up state.

In addition, the locking element may be a lug, and the support element may include a hook for connection to the lug.

With that, a locking element simple to operate is provided.

In a further example of the holding fixture of the present invention, the transmitting coil may be integrated in the support frame, in which case the transmitting coil includes a plurality of windings that extend around the window region.

In this instance, the transmitting coil is situated permanently in the support frame and wound around the window region. In this manner, the transmitting coil produces a resonant inductive coupling acting at least partially through the window region. This eliminates the need for adapting the holding device to charge a supported, mobile terminal.

The present invention provides a system including a holding fixture as disclosed herein, and a module; the holding fixture being connected to the module, and the window region being situated over the module.

Advantages and effects, as well as further refinements, of the system are derived from advantages and effects, as well as further refinements, of the holding device described above. Thus, in this regard, reference is made to the preceding description.

The holding fixture detachably connected to the module.

Further features, details and advantages of the present invention are derived from the description below of exemplary embodiments in light of the figures.

### BRIEF DESCRIPTION OF THE DRAWINGS

FIGS. 1A and 1B show a schematic representation of a system and a control device in accordance with an example embodiment of the present invention.

FIG. 2 shows a schematic representation of a separate support element, in accordance with an example embodiment of the present invention.

FIGS. 3A and 3B show a schematic representation of a rollable support element, in accordance with an example embodiment of the present invention.

FIG. 4 shows a schematic representation of a transmitting coil wound around the window region, in accordance with an example embodiment of the present invention.

### DETAILED DESCRIPTION OF EXAMPLE EMBODIMENTS

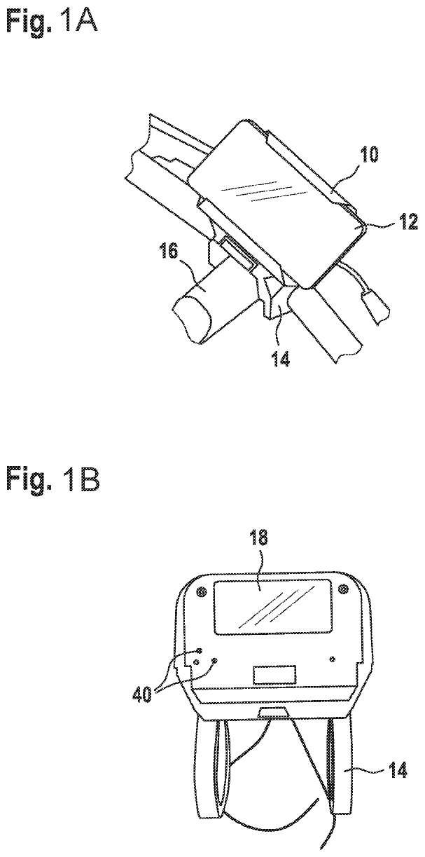

FIG. 1A shows a holding fixture 10 and a module 14, which includes fastening elements for attaching the holding fixture and is mounted to handlebars 16 of a bicycle. Module 14 may be, for example, a control unit. Holding fixture 10 supports a mobile terminal 12 in the form of a smartphone. Holding fixture 10 is fastened to module 14 with the aid of a mechanical structure and remains securely mounted, even if mobile terminal 12 is removed from holding fixture 10 and is no longer used for cycling. In this context, holding fixture 10 may be detachably connected to module 14.

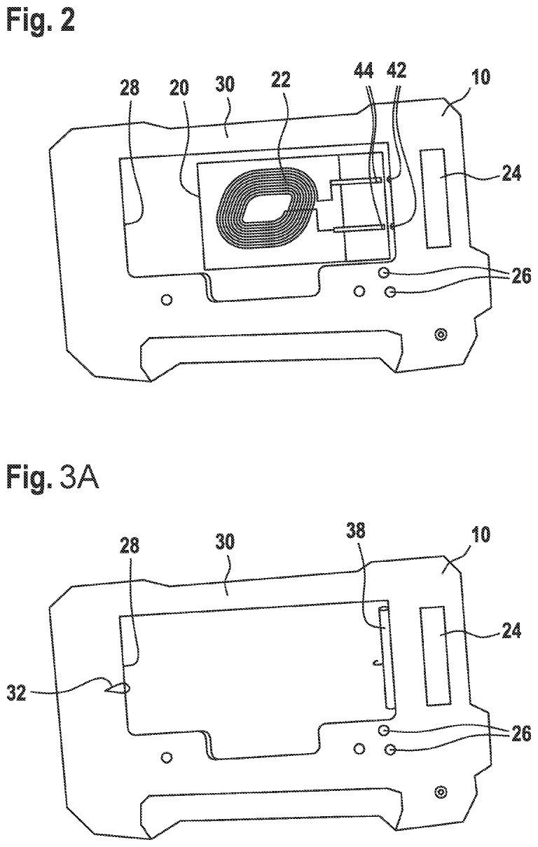

In addition, holding fixture 10 has an open window region 28 in the center, which is bounded by a support frame 30 that is shown in FIGS. 2 through 4. This window region 28 is additionally advantageous, if module 14 includes its own built-in display 18, as shown in FIG. 1B, or operating elements. Built-in display 18 is only used to output information, if mobile terminal 12 is not in holding fixture 10. After mobile terminal 12 has been inserted into holding fixture 10, the information outputted may be displayed automatically or manually on a video screen of mobile terminal 12. The absence of material in window region 28 promotes resonant inductive coupling through window region 28.

Holding fixture 10 may be a universal holder for securing different mobile terminals.

Control device 14 also includes electrical contacts 40, which are used for supplying electrical voltage. These electrical contacts 40 may be connected to holding device 10, so that holding fixture 10 may effect contactless charging of a supported mobile terminal 12 with the aid of a transmitting coil.

According to FIG. 2, a transmitter unit 24 for generating a resonant inductive coupling is built into holding fixture 10, e.g., along the right edge with respect to the two electrical contacts 26 of holding device 10. Transmitter unit 24 may be, e.g., a Qi transmitter.

A transmitting coil 22 of transmitter unit 24 is mounted on a separate support element 20, which may be an external, thin plastic substrate with a protective measure. In this context, holding fixture 10 includes a first electrical connecting element 42, and support element 20 includes a second electrical connecting element 44, which may have two electrically conductive plug pins.

With the aid of second electrical connecting element 44, support element 20 may be inserted into first electrical connecting element 42 of support frame 30. Second electrical connecting element 44 may also be used as an electrical connection between transmitting coil 22 and transmitter unit 24. If a mobile terminal 12 is not in holding fixture 10, then wireless charging is not needed. Separate support element 20 may then be removed from holding fixture 10. The user may then see built-in display 18 of module 14 through window region 28 of holding fixture 10. If mobile terminal 12 is used as a display, the separate support element 20 having transmitting coil 22 is inserted into holding fixture 10, and subsequently, mobile terminal 12 is placed into holding fixture 10. Transmitter unit 24 receives the operating voltage from electrical contacts 26 of holding fixture 10, which are connected to electrical contacts 40 of control unit 14.

The dimensions of separate support element 20 for transmitting coil 22, as well as the position and shape of transmitting coil 22, may be optimized in such a manner, that the efficiency of power transmission is optimized with the mechanical boundary conditions for holding fixture 10.

The further example of the holding fixture according to FIG. 3A is based on a rollable transmitting coil 22, which is incorporated completely in holding fixture 10. In this context, for example, an installation region for rollable transmitting coil 22 is situated to the right of the open section of holding fixture 10. One end of rollable transmitting coil 22 is fixed in position on a roll cylinder 38 securely mounted in the installation region of holding fixture 10.

FIG. 3B shows the unrolled state of a rollable transmitting coil 22, which is elastic and goes back into the rolled state in the absence of a tensile force. In addition, at roll cylinder 38, transmitting coil 22 is connected electrically to the transmitter unit 24 embedded in holding fixture 24. In this context, roll cylinder 38 may be mounted on a short or long side of support frame 30. It is also possible for roll cylinder 38 to be situated diagonally at a corner of support frame 30 and to be able to be unrolled diagonally across window region 28.

Roll cylinder 38 may be a flexible band 34, on which a flexible coil in the form of transmitting coil 22 is situated.

A hook 36 for securing transmitting coil 22 in the pulled-out state is on the other end of transmitting coil 22. A locking element 32, which, e.g., may take the shape of a lug and is intended for securing hook 36 of rollable transmitting coil 22, is situated on the left edge of window region 28 of holding fixture 10. If mobile terminal 12 is intended to be used as a display of module 14, then rollable transmitting coil 22 having hook 36 is pulled out of its installation region of support frame 30, and hook 36 is retained by locking element 32. Subsequently, the mobile terminal may be inserted into holding fixture 10. If built-in display 18 of module 14 is used for outputting information, hook 36 must be detached from locking element 32, and rollable transmitting coil 22 must go back again into its installation region of holding fixture 10, due to its elastic force. It should be pointed out that the retention of rollable transmitting coil 22 in the pulled-out state by a hook 36 and a locking element 32 is only one of the many implementation options, which is considered here as an exemplary embodiment due to its simplicity.

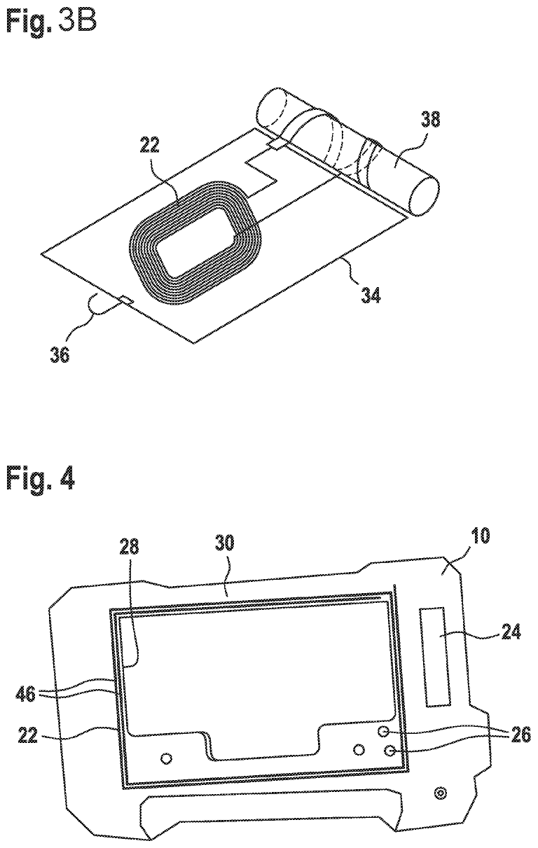

In a further example of holding fixture 10, as shown in FIG. 4, a plurality of windings 46 of transmitting coil 22 of transmitter unit 24 are wound along the edges of window region 28 of holding fixture 10. Among the boundary conditions for window region 28, the mechanical design of window region 28 is optimized in such a manner, that the transmitting coil 22 of transmitter unit 24 wound in this manner produces the maximum efficiency of power transmission during wireless charging of common mobile terminals 12. Transmitter unit 24 is still embedded in holding fixture 10 and is connected electrically to the two ends of windings 46.

1-10. (canceled)

11. A holding fixture for fastening a mobile terminal to a module having fastening elements for attaching the holding fixture, the mobile terminal including a charging coil for contactlessly charging an energy store, the holding fixture comprising:
a window region;
a support frame configured to hold the mobile terminal and for attachment to the module, the support frame extending about the window region, and the window region being covered by a supported mobile terminal, when the holding fixture is attached to the module;
a transmitter unit configured to generate a resonant inductive coupling with the charging coil, and using a transmitting coil, the transmitter unit configured to generate a resonant inductive coupling acting at least partially through the window region.

12. The holding fixture as recited in claim 11, wherein the transmitting coil is situated on a separate support element, and the support element is detachably connected to the support frame.

13. The holding fixture as recited in claim 12, wherein the support element is detachably connected to the holding fixture and extends, in a connected state, from the support frame into the window region.

14. The holding fixture as recited in claim 13, wherein the support frame includes a first electrical connecting element, and the support element includes a second electrical connecting element for connection to the first electrical connecting element.

15. The holding fixture as recited in claim 12, wherein the support element and the transmitting coil have a rolled-up state and an unrolled state and extend, in an unrolled state, from the transmitter unit across the window region.

16. The holding fixture as recited in claim 15, wherein the support frame includes a locking element configured to detachably retain the support element in the unrolled state.

17. The holding fixture as recited in claim 16, wherein the locking element is a lug, and the support element includes a hook configured to connect to the lug.

18. The holding fixture as recited in claim 11, wherein the transmitting coil is integrated in the support frame, and the transmitting coil includes a plurality of windings which extend around the window region.

19. A system, comprising:
a holding fixture; and
a module having fastening elements for attaching the holding fixture;
wherein the holding fixture is configured to fasten a mobile terminal to the module, the mobile terminal including a charging coil for contactlessly charging an energy store, the holding fixture including:
a window region,
a support frame configured to hold the mobile terminal and for attachment to the module, the support frame extending about the window region, and the window region being covered by a supported mobile terminal, when the holding fixture is attached to the module,
a transmitter unit configured to generate a resonant inductive coupling with the charging coil, and using a transmitting coil, the transmitter unit configured to generate a resonant inductive coupling acting at least partially through the window region;
wherein the holding fixture is connected to the module, and the window region is situated over the module.

20. The system as recited in claim 19, wherein the holding fixture is detachably connected to the module.
